(19) United States
(12) Patent Application Publication
(10) Pub. No.: US 2017/0341473 A1
(43) Pub. Date: Nov. 30, 2017

(54) DEVICE FOR ATTENUATING ROLLING NOISE FOR A TIRE

(71) Applicant: COMPAGNIE GENERALE DES ETABLISSEMENTS MICHELIN, Clermont-Ferrand (FR)

(72) Inventor: Gael ROTY, Clermont-Ferrand (FR)

(21) Appl. No.: 15/535,395

(22) PCT Filed: Dec. 11, 2015
(86) PCT No.: PCT/EP2015/079486

§ 371 Date: Jun. 12, 2017

(30) Foreign Application Priority Data
Dec. 12, 2014 (FR) 1462345

(51) Int. Cl. B60C 11/13; B60C 11/04

(52) U.S. Cl. CPC B60C 11/1307; B60C 11/1353; B60C 11/042; B60C 2011/1361; B60C 2011/1338

(57) ABSTRACT

The subject of the disclosure is a tread for a tire, this tread having a tread surface intended to come into contact with a roadway and comprising at least one groove of width W and depth P delimited by two facing lateral walls, these lateral walls being connected together by a groove bottom. At least one groove has a plurality of closing devices for reducing the running resonance noise generated by this groove, each closing device comprising at least two flexible blades, a first flexible blade secured to the bottom of the groove and intended to flex around a first axis, and a second flexible blade secured to a lateral wall delimiting the groove and intended to flex around a second axis, the first flexible blade connected to the bottom having a maximum height H.

### BACKGROUND

This application is a 371 national phase entry of PCT/EP2015/079486, filed 11 Dec. 2015, which claims the benefit of French Patent Application No. 1462345, filed 12 Dec. 2014, the contents of which are incorporated herein by reference for all purposes.

The present disclosure relates to tire treads and more particularly treads comprising grooves, the latter being provided with closing devices for reducing the noise generated by the air made to resonate in these grooves during rolling.

Conventionally, a tire comprises a tread intended to be in contact with a road while a vehicle provided with tires is being driven. This tread is provided with a tread pattern formed by raised elements, these elements delimiting grooves for draining water present on the road during wet weather. However, the presence of grooves, and notably of circumferentially oriented grooves, is a source of rolling noise.

A block is a raised element formed on the tread, said element being delimited by voids or grooves and comprising lateral walls and a contact face intended to come into contact with the roadway. This contact face has a geometric center defined as being the barycenter or center of gravity of the face.

A rib is a raised element formed on a tread, this element extending in the circumferential direction and making a complete circuit of the tire. A rib comprises two lateral walls and a contact face, the latter being intended to come into contact with the roadway during rolling.

A radial direction is understood to mean in the present document any direction which is perpendicular to the axis of rotation of the tire (this direction corresponds to the direction of the thickness of the tread).

A transverse or axial direction is understood to mean a direction parallel to the axis of rotation of the tire.

A circumferential direction is understood to mean a direction tangential to any circle centered on the axis of rotation. This direction is perpendicular both to the axial direction and to a radial direction.

A groove denotes the space delimited by facing walls of material, these walls being connected together by a groove bottom. Under the usual rolling conditions, the walls delimiting this groove cannot come into contact with one another.

The tread surface of a tread corresponds to the surface of the tread that is intended to come into contact with ground during rolling of a tire provided with such a tread.

It is known that, as a tread enters the contact region in which it is in contact with a road during rolling, air is made to circulate in each groove. With the road, each groove forms a sort of tube having two open ends, the length of the tube corresponding to the length of the contact patch.

The air contained in this tube forms a column of air that is made to vibrate during rolling and the resonant frequency of which depends on the length separating the two ends of the tube and consequently on the length of groove in contact with the roadway.

This resonance of the air in the grooves has the consequence of generating, in a vehicle equipped with these tires, a noise inside the vehicle and a noise outside the vehicle. These inside and outside noises frequently correspond to a frequency close or equal to 1 kHz, which corresponds to a frequency to which the human ear is particularly sensitive.

In order to reduce such resonance noise, it is known (see for example the patent document FR 2715891) to arrange in each groove of circumferential or generally circumferential orientation, a plurality of noise attenuating devices, each device being composed of membranes or relatively thin flexible blades of rubber compound, each membrane or flexible blade occupying the entire cross section of the groove or at least a large portion of this cross section so as to form a closing device. The installation of these flexible blades changes the length of each air pipe and thus makes it possible to change the resonant frequency. This results in a change in the perceived noise. The elastic nature of the material of each flexible blade also ensures sufficient return forces for returning the flexible blades into a position closing the groove when liquid is no longer flowing in said groove.

Each flexible blade can extend from the bottom of the groove or be fixed to at least one of the walls delimiting said groove. Relatively thin is understood to mean that each flexible blade is able to flex in order to at least partially open the cross section of the groove under the effect of a flow of liquid notably when driving in the wet. These same blades remain in the position closing the groove when driving in the dry. As has been recalled above, the devices formed of flexible blades that are described in the prior art—on account of the need to be able to flex under a flow of liquid—are connected either to the bottom of a groove or to one of the lateral walls delimiting a groove.

By virtue of these flexible blades, the length of the column of air in each circumferential groove is reduced compared with the overall length of the groove in the contact, and this results in a change in the resonant frequency. The shift in frequency is toward resonant frequency values to which the human ear is less sensitive.

In devices formed of a single blade carried by the bottom of a groove of given depth, it is sometimes difficult to reconcile good molding and good flexibility of the blade. This is because the greater the height of the flexible blade and the finer the inflow of material during molding, the smaller the thickness of each flexible blade. This state of affairs causes a person skilled in the art to make certain compromises, notably with regard to the thickness of the flexible blade. This results in greater rigidity in the new state for each flexible blade, this increase in rigidity being even more appreciable in the part-worn state.

The documents DE 44 03 662 A1 and JP 2007/210569 describe tires provided with noise reducing devices.

The document EP 908330-B1 discloses a noise reducing device, said device being formed by three flexible blades, two of which are fixed to the walls delimiting a groove, and the third of which is fixed to the bottom of this groove. In this arrangement, the blade fixed to the bottom extends as far as the tread surface in the new state and raises the same production problems as those already mentioned. Furthermore, the two other blades are not sufficiently flexible.

### SUMMARY

The present disclosure proposes a solution to this problem.

The expression “lateral wall delimiting a groove” is interpreted in the present document as denoting one or the other of the facing lateral walls, these walls being connected together by a groove bottom. The height of the groove bottom corresponds to the legal wear limit indicated by at least one wear indicator.

The present disclosure is an improvement of the groove closing devices allowing a reduction in resonance noise, and aims both to obtain easy molding and demolding of the flexible blades forming the device for closing the grooves and complete closure of the groove.

To this end, the subject of the disclosure is a tread for a tire, this tread having a tread surface intended to come into contact with a roadway and comprising at least one groove of width W and depth P delimited by two facing lateral walls, these lateral walls being connected together by a groove bottom. At least one groove has a plurality of closing devices for reducing the running resonance noise generated by this groove, each closing device comprising at least two flexible blades, a first flexible blade secured to the bottom of the groove and intended to flex around a first axis, and a second flexible blade secured to a lateral wall delimiting the groove and intended to flex around a second axis, the first flexible blade connected to the bottom having a maximum height H. This tread is configured such that the blades have geometries that are suitable for cooperating with one another so as to close at least 70% of the cross section of the groove. Furthermore, the thickness of the first flexible blade carried by the groove bottom is less than the thickness of each second flexible blade carried by a lateral wall.

By virtue of this device, the first flexible blade can flex around a first axis passing through the points of contact of the end wall of this blade with the bottom of the groove; flexion under the effect of a liquid flowing through the groove causes the first flexible blade to be pressed against the bottom of the groove. The second flexible blade connected to a lateral wall delimiting the groove tends to flex around an axis parallel to said wall; flexion under the effect of a liquid flowing through the groove causes the second flexible blade to be pressed against the lateral wall.

In the case of a small height of liquid flowing through the groove, only the flexible blades fixed to the lateral walls are subjected to flexion, this being favorable from the point of view of the wear to these blades during rolling.

As a variant of the disclosure, the fact should be considered that there may be several flexible blades fixed to the bottom of the groove, these flexible blades forming a first blade as described above.

More preferably, the maximum height H of each first flexible blade fixed to the bottom is at most equal to 80% of said depth and even more preferably at most equal to 50% of the depth P in the new state.

Advantageously, the first flexion axis is perpendicular or virtually perpendicular to the second flexion axis.

Each flexible blade comprises two main faces that are separated from one another by a distance corresponding to the thickness of the blade. These two main walls are connected by an edge, the geometry of which is suitable for meeting the condition of closing the groove.

In an advantageous variant, the second flexible blades have an internal edge that makes a non-zero average angle with a direction tangential to the tread surface in the new state.

Preferably, this average angle of the internal edge of the second flexible blades is at least equal to 20° in order to make demolding easier by reducing the forces that act on the blades during this demolding operation.

Advantageously, the flexible blades of the device according to the disclosure cooperate so as to close the cross section of the groove over at least 90% of the cross section of said groove.

Advantageously, the thickness of each first flexible blade connected to the bottom is at most equal to 0.4 mm and even more advantageously at most equal to 0.3 mm.

In one variant of the disclosure, the noise reducing device formed in a groove comprises a first flexible blade of triangular geometry connected to the bottom of the groove and at least one second flexible blade which is carried on a lateral wall and the geometry of which is complementary to that of the first blade.

In another variant, the noise reducing device formed in a groove comprises a first flexible blade of triangular geometry connected to the bottom of the groove, this first blade itself being formed of at least two blades, and at least one second flexible blade which is carried on a lateral wall and the shape of which is complementary to that of the first blade. In this variant of the disclosure, the division of the first flexible blade carried by the bottom of the groove into a plurality of blades makes it possible to maintain a certain aptitude for flexion even after partial wear to this first blade.

In another variant, the noise reducing device formed in a groove comprises a first flexible blade of triangular geometry connected to the bottom of the groove and at least one second flexible blade which is carried on a lateral wall and the shape of which is complementary to that of the first blade, these first and second flexible blades being offset from one another in the main direction of the groove so as to be able to create a slight overlap between said blades and thus to obtain a larger degree of closure of the cross section of the groove.

The main direction of a groove is understood here to mean the direction taken by the fluids flowing through said groove.

By virtue of the device according to the disclosure, it is possible, in the new state, to close the entire groove while retaining significant flexibility of each part of the device, regardless of the state of wear to the tread.

The degree of closure of a device according to the disclosure corresponds to the percentage of the cross section of the groove that is closed by such a flexible blade in a given state of wear. A degree of closure equal to 100% in the new state means that the cross section of the groove is entirely closed by the device in the new state.

This noise reducing device can of course be employed with any type of groove, be it a groove of circumferential orientation or transverse or oblique orientation.

Further features and advantages of the disclosure will become apparent from the following description with reference to the appended drawings which show, by way of nonlimiting examples, embodiments of the subject matter of the disclosure.

### BRIEF DESCRIPTION OF THE FIGURES

FIG. 1 shows a surface view of a tread according to the disclosure in the new state;

FIG. 2 shows a device according to the disclosure in a position closing a groove;

FIG. 3 shows the device from FIG. 2 in an open position under the action of a flow of liquid in the groove;

FIG. 4 shows a variant of the disclosure in a position closing a groove;

FIG. 5 shows a variant of the disclosure in a position closing a groove;

FIG. 6 shows another variant of the disclosure in a position closing a groove;

FIG. 7 shows a surface view of the variant shown in FIG. 6.

### DETAILED DESCRIPTION

For the figures accompanying this description, identical reference signs can be used to denote variants of the disclosure where these reference signs refer to elements of the same kind, whether structurally or functionally.

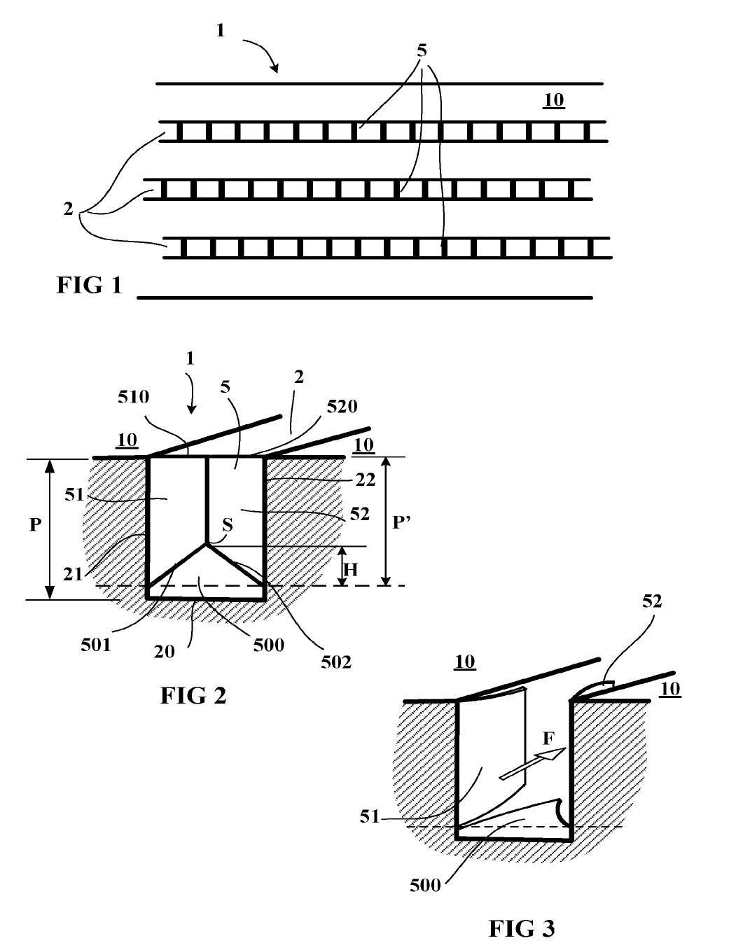

FIG. 1 shows a partial view of the surface of a tire tread, this tread comprising three grooves 2 of circumferential orientation. In order to reduce the noise associated with the resonance of air in each groove on passing through the contact with the road, a plurality of noise reducing devices according to the disclosure are formed in each groove, each device being formed of several flexible blades.

In FIG. 2, one of these devices 5 is shown in the closed state, that is to say in a position such that the cross section of the groove 2 is completely closed—in this case the cross section of the groove is closed over 90% of its area—by this device 5 in order to reduce the length of the air-filled pipe that can start to resonate during contact with a road, specifically in order to prevent the air from circulating.

In this FIG. 2, a groove 2 of generally circumferential orientation formed on the tread 1 can be seen. This groove 2 is delimited by lateral walls 21, 22 of raised elements, these facing lateral walls being connected by a groove bottom 20. This groove 2 has a total depth P in the new state, that is to say before any rolling and thus before any wear. The tread has a tread surface 10 intended to come into contact with the roadway during rolling. With wear, this tread surface changes and approaches the bottom of the grooves. In order to retain a sufficient drainage capacity with regard to safety, provision is made to dispose indicators of the wear limit not to be exceeded in the grooves. This wear limit is generally set by national legislatures (a dashed line is indicated in FIG. 2 and is located at a depth P′ less than the depth P of the groove).

A plurality of devices 5 for reducing noise generated by resonance have been formed in this groove 2, each device 5 being formed, in this first variant of the disclosure, by a first flexible blade 500 and two second flexible blades 51, 52, all of these flexible blades being made of rubber material of the same kind as the material of which the tread is made. The first flexible blade 500 is fixed to the bottom 20 of the groove, that is to say to the part connecting the lateral walls 21, 22, specifically to height equal to the wear limit fixed by the regulations. This first flexible blade 500 is secured to the bottom of the groove and has two free edges 501, 502 for forming an isosceles triangle geometry, these free edges meeting at an apex S, this apex S being located at a distance H from the bottom of the groove that is substantially equal to 15% of the total depth P of the groove. This first flexible blade 500 has a thickness equal to 0.4 mm.

Each second flexible blade 51, 52 is secured to one of the lateral walls 21, 22, respectively, and extends widthwise in the groove over about 50% of this width. Each second flexible blade 51, 52 has an upper edge 510, 520, respectively, these edges being intended to come into wearing contact with the road during rolling, and a lower edge 511, 521, respectively, these lower edges being intended to face an edge 501, 502 of the first blade 500 in order to ensure complementarity and thus to close the cross section of the groove. The two second flexible blades 51, 52 are positioned so as to face one another in order to ensure, with the first blade, that the groove is closed over at least 70% of the cross section of this groove.

In the present case, the first blade 500 fixed to the bottom 20 of the groove is intended to flex around an axis joining the points of intersection of the end wall of this first blade with the bottom of the groove (this axis is parallel to the direction indicated by the dashed line in FIG. 2).

In this variant, the flexible blades are suitable for flexing under the action of a force generated by a flow of liquid notably when driving over a roadway covered with water, as shown in FIG. 3, which shows the device 5 from FIG. 2 in an open position. The arrow F indicates the direction of a flow of liquid flowing inside the groove. It is under the action of this flow that the flexible blades forming the device 5 flex around an axis parallel to the direction of the connection between the flexible blade and the wall carrying said blade.

In this variant, the second flexible blades 51, 52 have a thickness equal to 1 mm, while the first flexible blade fixed to the bottom of the groove has a thickness equal to 0.6 mm. The choice of a smaller thickness for the first blade is very favorable since it makes it possible to reduce the force needed to flex this blade, regardless of the level of wear to the tread.

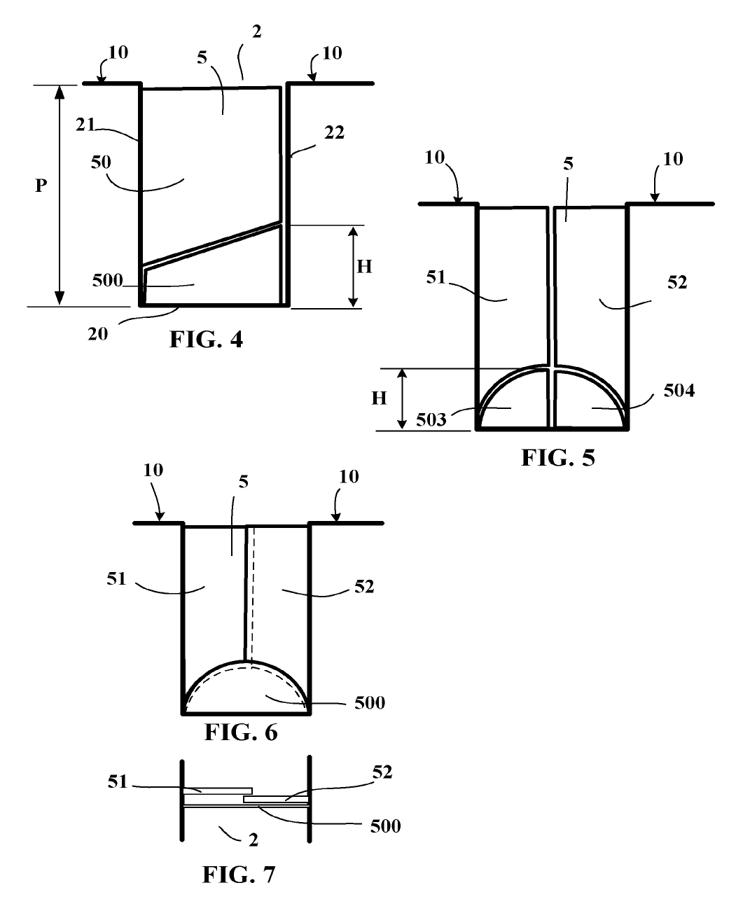

In a variant shown in FIG. 4, a noise reducing device 5 according to the disclosure comprises a first blade 500 and a second blade 50. The first flexible blade 500 connected to the bottom 20 of a groove has a trapezoidal geometry, one of its sides following the profile of a lateral wall 21 delimiting the groove over a height H corresponding to the maximum height of this first blade measured with respect to the innermost point of the bottom 20 of the groove. Furthermore, the second blade 50 connected to a lateral wall has a geometry complementary to that of the first blade and extends over the entire width of the groove 2 in order to close the cross section of the groove virtually completely.

In another variant, shown in FIG. 5, a device 5 according to the disclosure comprises a first blade 500 and two second blades 51, 52. The first flexible blade 500 connected to the bottom of a groove is composed of two flexible blades 503, 504 that are separated from one another along a cut oriented in the direction of the depth of the groove. This first blade 500 has an edge which follows a semicircular geometry, the radius of this semicircle in this case being equal to half the width of the groove. The device also comprises two second blades 51, 52 complementary to the first blade in order to close the cross section of the groove over at least 70% of this cross section.

The first and second flexible blades of the variants described by way of the variants shown in FIGS. 1 to 5 are disposed in the same plane.

In another variant, shown in FIG. 6, a noise reducing device according to the disclosure is similar to the one shown in FIG. 5, except that the first and second flexible blades are not all positioned in the same plane. Specifically, an offset has been created between the blades so as to be able to create a slight overlap between the blades and thus to ensure a better degree of closure of the cross section of the groove. The space between the blades is as small as possible while satisfying the manufacturing constraints.

In FIG. 7, which shows the tread surface of the tread in the new state, it can be seen in the groove 2 that the first flexible blade 500 and second flexible blades 51, 52 are disposed with a slight offset with respect to one another in the main direction of the groove so as to allow a slight overlap therebetween and thus to increase the degree of closure and therefore increase the effectiveness of the device.

While the disclosure has been described in general terms and using a number of variants, it should be understood that this disclosure is not limited just to these variants shown and described. Notably, when the lateral walls delimiting a groove make an angle other than 90 degrees with the tread surface in the new state, it is easy for a person skilled in the art to adapt the geometries of each blade to allow the cross section of the groove to be opened when driving over a roadway covered with water. Furthermore, the variants described here can be combined with one another by a person skilled in the art depending on the objective being pursued, without departing from the scope of the disclosure as defined by the claims.

1. A tread for a tire, comprising:
a tread surface including at least one groove of depth P delimited by two facing lateral walls, the two facing lateral walls being connected together by a groove bottom,
at least one groove with a plurality of closing devices for reducing the running resonance noise generated by the at least one groove, each closing device comprising at least two flexible blades, a first flexible blade secured to the bottom of the groove and able to flex around a first axis, and a second flexible blade secured to a lateral wall delimiting the groove and intended to flex around a second axis, the first flexible blade connected to the bottom having a maximum height H, wherein the flexible blades are configured such that they have geometries to cooperate with one another to close at least 70% of the cross section of the groove, and the thickness of the first flexible blade is carried by the groove bottom is less than the thickness of each second flexible blade carried by a lateral wall.
The tread according to claim 1, wherein the maximum height H of the flexible blade fixed to the bottom is at most equal to 80% of the depth P of the groove.

3. The tread according to claim 1, wherein the first flexion axis of the first flexible blade is perpendicular to the second axis of the second flexible blades.

4. The tread according to claim 1, wherein the flexible blades have an edge that makes a non-zero average angle with a direction tangential to the tread surface in the new state.

5. The tread according to claim 4, wherein the average angle of the internal edge of the second flexible blades is at least equal to 20° to a transverse direction.

6. The tread according to claim 1, wherein the flexible blades of the device cooperate to close the cross section of the groove over at least 90% of this cross section.

7. The tread according to claim 1, wherein the noise reducing device formed in a groove comprises a first flexible blade of triangular geometry connected to the bottom of the groove and at least one second flexible blade which is carried on a lateral wall and the geometry of which is complementary to that of the first blade.

8. The tread according to claim 1, wherein the noise reducing device formed in a groove comprises a first flexible blade of triangular geometry connected to the bottom of the groove, this first blade itself being formed of at least two blades, and at least one second flexible blade which is carried on a lateral wall and the shape of which is complementary to that of the first blade.

9. The tread according to claim 1, wherein the noise reducing device formed in a groove comprises a first flexible blade of triangular geometry connected to the bottom of the groove and at least one second flexible blade which is carried on a lateral wall and the shape of which is complementary to that of the first blade, these first and second flexible blades being offset from one another in the main direction of the groove so as to be able to create a slight overlap between said blades and thus to obtain a larger degree of closure of the cross section of the groove.

10. The tread according to claim 1, wherein the thickness of each first flexible blade (500) connected to the bottom is at most equal to 0.4 mm and even more preferably at most equal to 0.3 mm.
